(19) United States
(12) Patent Application Publication
(10) Pub. No.: US 2026/0172514 A1
(43) Pub. Date: Jun. 18, 2026

(54) MEDIUM FEEDING DEVICE AND RECORDING APPARATUS

(71) Applicant: SEIKO EPSON CORPORATION, TOKYO (JP)

(72) Inventor: Yoshikazu KOIKE, CHINO-SHI (JP)

(21) Appl. No.: 19/424,186

(22) Filed: Dec. 18, 2025

(30) Foreign Application Priority Data
Dec. 18, 2024 (JP) 2024-221433

(51) Int. Cl. H04N 1/00; B41J 11/00

(52) U.S. Cl. CPC H04N 1/00612; H04N 1/00602; H04N 1/00673; B41J 11/007

(57) ABSTRACT

A raising and lowering unit, which raises and lowers a support unit, performs, every time a medium is fed, switching of a first state in which rising of the support unit is allowed and a second state in which the rising of the support unit from a restriction position between a most raised position and a most lowered position to a position higher than the restriction position is restricted. According to a decrease in the number of stacked media on the support unit, the position of the support unit in the second state moves from a position lower than the restriction position to the restriction position, a state in which the medium supported by the support unit is in contact with a feeding roller is maintained, and when at least the number of stacked media is one, in the second state, the support unit is at the restriction position, and the medium supported by the support unit is separated from the feeding roller.

The present application is based on, and claims priority from JP Application Serial Number 2024-221433, filed Dec. 18, 2024, the disclosure of which is hereby incorporated by reference herein in its entirety.

### BACKGROUND

### 1. Technical Field

The present disclosure relates to a medium feeding device that feeds a medium and a recording apparatus including the medium feeding device.

### 2. Related Art

A sheet conveying device described in JP-A-2021-66595 includes a sheet tray that supports a feeding target sheet, a tray driving mechanism that moves the sheet tray in the up-down direction according to the number of stacked media supported by the sheet tray, and a sheet sensor that is a sensor provided between a feeding roller and a separating unit and detects presence or absence of a sheet supported by the sheet tray.

After the sheet sensor detects that sheets supported by the sheet tray run out, a control unit of the sheet conveying device controls the tray driving mechanism to execute an operation of moving the sheet tray downward. Accordingly, abnormal noise at the time when the feeding roller slips against the sheet tray and wear of the feeding roller are suppressed.

JP-A-2003-72958 discloses a paper feeding device having a small release mode in addition to a non-release mode and a large release mode in order to suppress noise caused by printing paper powerfully colliding with a paper feeding roller when a hopper is displaced from a standby position to a paper feeding position. The non-release mode is a mode for bringing the uppermost recording material into press contact with the paper feeding roller with an urging force of urging means. The large release mode is a mode for turning and holding the hopper to be most separated from the paper feeding roller. The small release mode is a mode for turning and holding the hopper such that the uppermost recording material is slightly separated from the paper feeding roller.

JP-A-2021-66595 and JP-A-2003-72958 are examples of the related art.

In the sheet conveying device described in JP-A-2021-66595, an actuator configuring the sheet sensor is provided in the vicinity of the feeding roller and further downstream than the feeding roller. Therefore, even when the sheet tray is moved downward after the sheet sensor detects that sheets on the sheet tray run out, a period in which the feeding roller comes into contact with the sheet tray occurs. As a result, noise at the time when the feeding roller slips against the sheet tray and wear of the feeding roller occur.

In order to avoid such a problem, in a configuration in which the hopper is lowered even slightly and then raised every time the recording material is fed as in the paper feeding device described in JP-A-2003-72958, a decrease in a paper feeding throughput is caused.

### SUMMARY

According to an aspect of the present disclosure, there is provided a medium feeding device including: a feeding unit configured to feed a medium; a support unit configured to support the medium, the support unit being capable of rising and falling between a most raised position that is a position where the support unit is closest to the feeding unit and a most lowered position that is a position where the support unit is most separated from the feeding unit; and a raising and lowering unit configured to raise and lower the support unit, wherein the raising and lowering unit switches, every time the medium is fed, a first state in which the rising of the support unit is allowed and a second state in which the rising of the support unit from a restriction position between the most raised position and the most lowered position to a position higher than the restriction position is restricted, when a number of stacked media on the support unit is a largest number, in the second state, the support unit is present at a position lower than the restriction position, the medium supported by the support unit comes into contact with the feeding unit, a position of the support unit in the second state moves from the position lower than the restriction position to the restriction position according to a decrease in the number of stacked media, and a state in which the medium supported by the support unit is in contact with the feeding unit is maintained, and, when at least the number of stacked media is one, in the second state, the support unit is present at the restriction position, and the medium supported by the support unit is separated from the feeding unit.

According to another aspect of the present disclosure, there is provided a recording apparatus including: the medium feeding device explained above; and a recording unit configured to perform recording on the medium fed by the medium feeding device.

### BRIEF DESCRIPTION OF THE DRAWINGS

FIG. 1 is a diagram illustrating a medium conveyance path of a printer.

FIG. 2 is a block diagram illustrating a control system of the printer.

FIG. 3 is a perspective view of a medium feeding device and is a diagram in the case in which a raising and lowering unit is in a third state.

FIG. 4 is a perspective view of the medium feeding device in which a placing unit is omitted and is a diagram in the case in which the raising and lowering unit is in the third state.

FIG. 5 is a perspective view of the medium feeding device in which the placing unit is omitted and is a diagram in the case in which the raising and lowering unit is in a first state.

FIG. 6 is a perspective view of the medium feeding device in which the placing unit is omitted and is a diagram in the case in which the raising and lowering unit is in a second state.

FIG. 7A is a diagram illustrating the position of a support unit supporting a largest number of media and is a diagram in the case in which the raising and lowering unit is in the first state or the second state.

FIG. 7B is a diagram in the case in which the raising and lowering unit is in the first state or the second state and the support unit is present at a restriction position.

FIG. 7C is a diagram illustrating the position of the support unit supporting one medium and is a diagram in the case in which the raising and lowering unit is in the second state and the support unit is present at the restriction position.

FIG. 7D is a diagram illustrating the position of the support unit supporting one medium and is a diagram in the case in which the raising and lowering unit is in the first state and the support unit is present above the restriction position.

FIG. 8 is a flowchart of feeding control.

FIG. 9 is a perspective view of a medium feeding device including a shock absorbing unit.

FIG. 10 is a diagram illustrating a configuration for switching a plurality of friction pads.

### DESCRIPTION OF EMBODIMENTS

The present disclosure will schematically be described below.

A medium feeding device according to a first aspect includes: a feeding unit configured to feed a medium; a support unit configured to support the medium, the support unit being capable of rising and falling between a most raised position that is a position where the support unit is closest to the feeding unit and a most lowered position that is a position where the support unit is most separated from the feeding unit; and a raising and lowering unit configured to raise and lower the support unit, wherein the raising and lowering unit switches, every time the medium is fed, a first state in which the rising of the support unit is allowed and a second state in which the rising of the support unit from a restriction position between the most raised position and the most lowered position to a position higher than the restriction position is restricted, when a number of stacked media on the support unit is a largest number, in the second state, the support unit is present at a position lower than the restriction position, the medium supported by the support unit comes into contact with the feeding unit, a position of the support unit in the second state moves from the position lower than the restriction position to the restriction position according to a decrease in the number of stacked media, and a state in which the medium supported by the support unit is in contact with the feeding unit is maintained, and, when at least the number of stacked media is one, in the second state, the support unit is present at the restriction position, and the medium supported by the support unit is separated from the feeding unit.

According to this aspect, when the number of stacked media on the support unit is the largest number, in the second state, the support unit is present at the position lower than the restriction position and the medium supported by the support unit comes into contact with the feeding unit. Since the position of the support unit in the second state moves from the position lower than the restriction position to the restriction position according to the decrease in the number of stacked media and the state in which the medium supported by the support unit is in contact with the feeding unit is maintained, it is possible to suppress a decrease in throughput of medium feeding without a rising and falling motion of the support unit intervening.

When at least the number of stacked media is one, in the second state, since the support unit is present at the restriction position and the medium supported by the support unit is separated from the feeding unit, it is possible to suppress a deficiency caused by the feeding unit and the support unit coming into contact.

As explained above, according to this aspect, it is possible to suppress a deficiency caused by the feeding unit and the support unit coming into contact while suppressing a decrease in throughput of the medium feeding.

A second aspect is an aspect dependent from the first aspect, wherein the support unit is located at the restriction position in the second state when the number of stacked media is equal to or less than half of the largest number of media.

According to this aspect, since the support unit is located at the restriction position in the second state when the number of stacked media is equal to or less than half of the largest number of media, the state in which the medium supported by the support unit is in contact with the feeding unit is maintained during feeding of half or more media among the largest number of media. Accordingly, it is possible to effectively suppress a decrease in throughput of the medium feeding.

A third aspect is an aspect dependent from the first aspect, wherein the support unit is located at the restriction position in the second state when the number of stacked media is five or less.

According to this aspect, since the support unit is located at the restriction position in the second state when the number of stacked media is five or less, the state in which the medium supported by the support unit is in contact with the feeding unit is maintained during feeding of a large number of media. Accordingly, it is possible to effectively suppress a decrease in throughput of the medium feeding.

Note that this aspect may be dependent from not only the first aspect described above but also the second aspect described above.

A fourth aspect is an aspect dependent from the first aspect, the medium feeding device further including a placing unit configured to support the medium in conjunction with the support unit, wherein the support unit moves relatively to the placing unit in the rising and falling, and the support unit and the placing unit form a same plane when the support unit is present at the most lowered position.

According to this aspect, the medium can be more appropriately supported by the placing unit. Note that this aspect may be dependent from not only the first aspect but also the second or third aspect.

A fifth aspect is an aspect dependent from the first aspect, wherein the raising and lowering unit includes a cam that is rotationally driven, the support unit includes a cam contact section that comes into contact with the cam, and the support unit is lifted and lowered by the rotation of the cam.

According to this aspect, the support unit can be raised and lowered by the cam with a simple configuration.

Note that this aspect may be dependent from not only the first aspect but also any one of the second to fourth aspects.

A sixth aspect is an aspect dependent from the fifth aspect, wherein the raising and lowering unit includes a pressing unit configured to press the support unit toward the most raised position, and the cam takes, in the first state, a first phase in which the cam is separated from the cam contact section and takes, in the second state, a second phase in which the cam presses down the cam contact section.

According to this aspect, the support unit can be raised and lowered by the pressing unit and the cam with a simple configuration.

A seventh aspect is an aspect dependent from the first aspect, wherein the raising and lowering unit includes a shock absorbing unit configured to absorb a shock at a time when the medium supported by the support unit comes into contact with the feeding unit according to the rising of the support unit.

According to this aspect, since the raising and lowering unit includes the shock absorbing unit that absorbs the shock at the time when the medium supported by the support unit comes into contact with the feeding unit according to the rising of the support unit, it is possible to suppress collision sound at the time when the medium supported by the support unit comes into contact with the feeding unit.

Note that this aspect may be dependent from not only the first aspect but also any one of the second to sixth aspects.

An eighth aspect is an aspect dependent from the seventh aspect, wherein the shock absorbing unit includes an extension spring that presses the support unit toward the most lowered position, and a pressing force of the extension spring increases when the support unit rises.

According to this aspect, since the shock absorbing unit includes the extension spring that presses the support unit toward the most lowered position, the shock absorbing unit can be easily configured. Since the pressing force of the extension spring increases when the support unit rises, it is possible to effectively reduce the shock at the time when the medium supported by the support unit comes into contact with the feeding unit.

A ninth aspect is an aspect dependent from the first aspect, wherein the support unit includes a friction section at a position facing the feeding unit.

In a configuration in which the support unit includes the friction section at the position facing the feeding unit, a deficiency caused by the feeding unit and the support unit coming into contact with each other is likely to occur. However, according to the first aspect described above, it is possible to suppress the deficiency caused by the feeding unit and the support unit coming into contact with each other while suppressing a decrease in throughput of the medium feeding.

A tenth aspect is an aspect dependent from the first aspect, wherein the support unit includes a friction section at a position facing the feeding unit, the friction section includes: a first friction section in which a coefficient of friction between the first friction section and the medium is a first coefficient of friction; and a second friction section in which a coefficient of friction between the second friction section and the medium is a second coefficient of friction larger than the first coefficient of friction, and the first friction section and the second friction section can be switched.

According to this aspect, since the first friction section and the second friction section can be switched, it is possible to implement more appropriate feeding by switching the first friction section and the second friction section according to a type of the medium.

Note that this aspect may be dependent from not only the first aspect but also any one of the second to eighth aspects.

An eleventh aspect is an aspect dependent from the tenth aspect, the medium feeding device including a control unit configured to control the switching of the first friction section and the second friction section, wherein the control unit selects the first friction section when a first medium is fed and selects the second friction section when a second medium having a larger coefficient of friction between media than the first medium is fed.

According to this aspect, since the switching of the friction section is automatically performed according to a type of the medium, the action effects of the ninth aspect described above can be securely obtained.

A recording apparatus according to a twelfth aspect includes: the medium feeding device according to any one of the first to eleventh aspects; and a recording unit configured to perform recording on the medium fed by the medium feeding device.

According to this aspect, in the recording apparatus, the action effects of any one of the first to eleventh aspects described above can be obtained.

A thirteenth aspect is an aspect dependent from the twelfth aspect, wherein the medium fed by the feeding unit faces

### The Recording Unit.

In a configuration in which the medium fed by the feeding unit faces the recording unit, a conveyance load applied to the medium by the feeding unit is likely to cause deterioration in recording accuracy. In particular, when media on the support unit run out and the feeding unit and the support unit come into direct contact with each other, the feeding unit receives frictional resistance from the support unit, rotation speed decreases, and a conveyance load is applied to the medium to cause deterioration in the recording accuracy. However, with the action effects of the first aspect described above, the feeding unit and the support unit are prevented from coming into contact with each other and it is possible to suppress deterioration in the recording accuracy.

The present disclosure is specifically be explained below.

An inkjet printer 1 that performs recording, by ejecting ink, which is an example of liquid, onto a medium represented by recording paper is explained below as an example of a recording apparatus. The inkjet printer 1 is hereinafter abbreviated as printer 1.

An X-Y-Z coordinate system illustrated in the figures is an orthogonal coordinate system in which a direction pointed by an arrow is a + direction and a direction opposite to the + direction is a −direction. A Y-axis direction is a medium width direction intersecting a conveyance direction of the medium and is an apparatus depth direction. In the present embodiment, among side surfaces forming the periphery of an apparatus main body 2, a side surface in a +Y direction is a back surface and a side surface in a −Y direction is a front surface.

An X-axis direction is an apparatus width direction and a +X direction viewed from an operator of the printer 1 is a left side and a −X direction viewed from the operator of the printer 1 is a right side.

A Z-axis direction is a vertical direction, that is, an apparatus height direction and a +Z direction is an upward direction and a −Z direction is a downward direction.

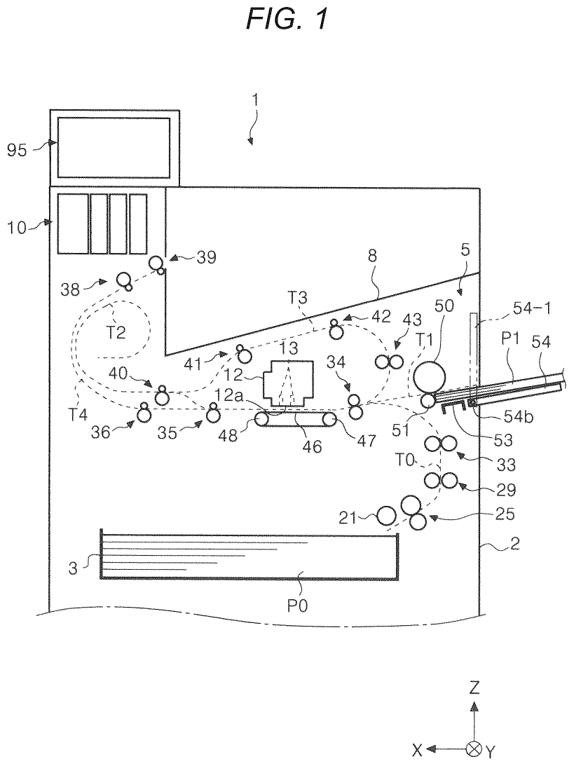

Hereinafter, a direction in which a medium is sent is sometimes referred to as “downstream” and the opposite direction of the direction is sometimes referred to as “upstream”. In FIG. 1, a medium conveyance path is indicated by a broken line. In the printer 1, the medium is conveyed through the medium conveyance path indicated by the broken line.

The printer 1 includes an operation panel 95 in an upper part of the apparatus main body 2 including a line head 12 explained below. The operation panel 95 includes a touch panel that receives various kinds of setting operation and displays various information. For example, a type of a medium on which recording is performed can be set via the operation panel 95. The type of the medium includes plain paper and thick paper.

A medium cassette 3 is provided in a lower part of the apparatus main body 2. Reference sign P0 denotes media stored in the medium cassette 3.

A pickup roller 21 that delivers the stored media in the-X direction is provided for the medium cassette 3. A feeding roller pair 25 that feeds the medium delivered by the pickup roller 21 to further downstream is provided for the medium cassette 3. A plurality of medium cassettes (not illustrated) are further provided below the medium cassette 3. A pickup roller (not illustrated) and a feeding roller pair (not illustrated) are provided for each of the plurality of medium cassettes (not illustrated).

Note that in the following explanation, unless particularly explained otherwise, it is assumed that “roller pair” includes a drive roller driven by a power source such as a motor and a driven roller driven to rotate in contact with the drive roller.

Reference sign T0 denotes a conveyance path of a medium delivered from the medium cassette 3 and reaching a conveyance roller pair 34. The medium delivered from the medium cassette 3 receives a sending force from conveyance roller pairs 29 and 33 and is sent to the conveyance roller pair 34.

A medium feeding device 5 is provided on the right side of the apparatus main body 2. Reference sign T1 denotes a conveyance path of the medium delivered from the medium feeding device 5 and reaching the conveyance roller pair 34.

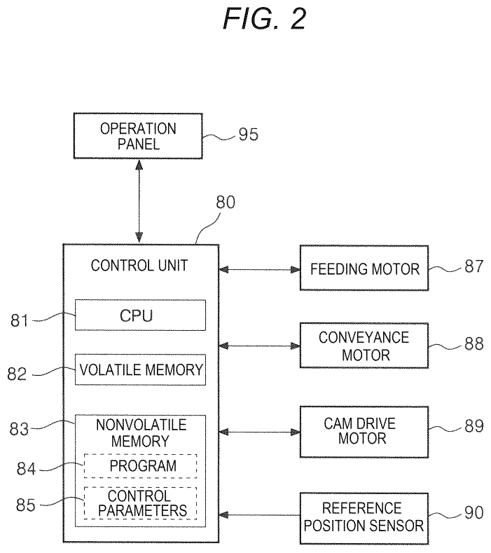

The medium feeding device 5 includes a feeding roller 50, a separation roller 51, a support unit 53, and a placing unit 54. The feeding roller 50 is an example of a feeding unit that feeds a medium and the feeding roller 50 is driven by a feeding motor 87 (see FIG. 2). The support unit 53 and the placing unit 54 support the medium. The support unit 53 is capable of rising and falling between a most raised position, which is a position where the support unit 53 is the closest to the feeding roller 50, and a most lowered position, which is a position where the support unit 53 is most distant from the feeding roller 50. The position of the support unit 53 is explained in detail below.

The placing unit 54 supports the medium in conjunction with the support unit 53. Reference sign P1 denotes a medium supported by the support unit 53 and the placing unit 54. The support unit 53 moves relative to the placing unit 54 when rising and falling. The placing unit 54 is provided to be capable of turning centering on a turning shaft 54b. Reference sign 54-1 denotes the placing unit 54 in a state of turning in the vertical direction to be closed.

The medium sent to the conveyance roller pair 34 is sent by the conveyance roller pair 34 to between the line head 12, which is an example of a recording unit, and a conveyance belt 46, that is, to a recording position facing the line head 12.

The line head 12 executes recording by ejecting ink, which is an example of liquid, onto the medium from nozzles 13 provided on a nozzle surface 12a. In the present embodiment, an ejection direction of the ink from the nozzles 13 is the-Z direction. The line head 12 is an ink ejection head in which a plurality of nozzles 13 for ejecting the ink are disposed to cover the entire region in the medium width direction and is configured as an ink ejection head capable of performing recording in the entire medium width region without moving in the medium width direction. However, the ink ejection head is not limited thereto and may be a type that is mounted on a carriage and ejects the ink while moving in the medium width direction.

A recording scheme is not limited to an inkjet scheme and may be a dot impact scheme or an electrophotographic scheme such as a laser scheme or an LED scheme.

The line head 12 according to the present embodiment ejects inks of a plurality of colors as an example. Specifically, in the present embodiment, the plurality of nozzles 13 include a plurality of nozzles 13 that eject yellow ink, a plurality of nozzles 13 that eject magenta ink, a plurality of nozzles 13 that eject cyan ink, and a plurality of nozzles 13 that eject black ink.

The conveyance belt 46 is an endless belt wound around a first roller 47, which is a drive roller, and a second roller 48, which is a driven roller, and is rotated by the first roller 47 being driven by a not-illustrated motor. The medium is conveyed at a position facing the line head 12 while being absorbed to a belt surface of the conveyance belt 46. An electrostatic adsorption scheme can be adopted for the adsorption of the medium to the conveyance belt 46. However, an air suction scheme may be adopted for the adsorption of the medium to the conveyance belt 46.

The medium, on a first surface of which recording has been performed by the line head 12, is sent toward either a conveyance roller pair 36 or a conveyance roller pair 40 by a conveyance roller pair 35 located downstream of the conveyance belt 46. A not-illustrated path switching flap is provided downstream of the conveyance roller pair 35. The medium that receives the sending force from the conveyance roller pair 35 is sent to either the conveyance roller pair 36 or the conveyance roller pair 40 by the path switching flap.

When recording is not performed on both of the first surface and a second surface opposite to the first surface of the medium, that is, when double-sided recording is not performed, the medium is fed from the conveyance roller pair 35 toward the conveyance roller pair 36 and is discharged toward a discharge tray 8 through a discharge path T4. A conveyance roller pair 38 and a conveyance roller pair 39 are provided in the discharge path T4.

When recording is performed on both of the first surface and the second surface opposite to the first surface of the medium, that is, when the double-sided recording is performed, the medium is sent from the conveyance roller pair 35 toward the conveyance roller pair 40 and enters a switchback path T2. Thereafter, a rotation direction of the conveyance roller pair 40 is switched, the medium enters a reversal path T3, and is sent to the conveyance roller pair 34 by conveyance roller pairs 41, 42, and 43.

Reference numeral 10 denotes an ink storage unit serving as a liquid storage unit that stores the ink before being ejected. The ink ejected from the line head 12 is supplied from the ink storage unit 10 to the line head 12 via a not-illustrated tube. The ink storage unit 10 stores, for example, black ink, yellow ink, magenta ink, and cyan ink.

The overall configuration of the printer 1 is as explained above. A control unit 80 that controls the printer 1 is explained below with reference to FIG. 2.

The control unit 80 performs various kinds of control including recording control in the printer 1. Note that, in FIG. 2, only elements necessary for explanation in the present specification are illustrated and other elements are not illustrated.

The feeding motor 87, a conveyance motor 88, a cam drive motor 89, and the operation panel 95 are electrically coupled to the control unit 80 as control targets.

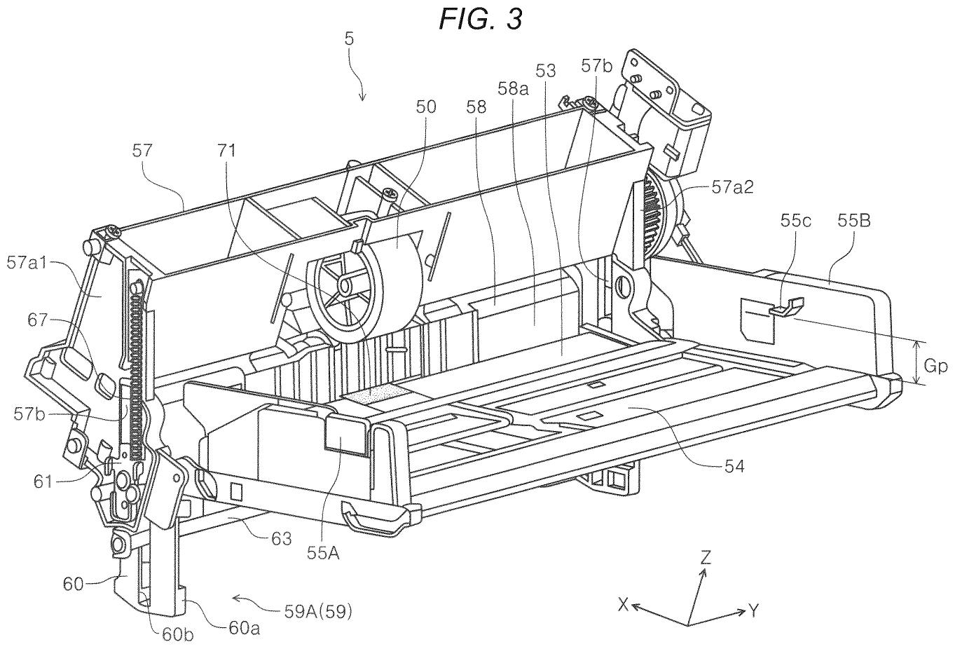

The feeding motor 87 is a power source of the feeding roller 50. The pickup roller 21 and the other feeding roller pairs explained above may be further driven by the feeding motor 87. The conveyance motor 88 is a power source of the conveyance roller pairs explained above. The cam drive motor 89 is a power source of a cam 64 (see FIGS. 3 to 6) explained below.

The motors described above are, for example, DC motors. Note that not-illustrated rotary encoders are provided in the motors. The control unit 80 can detect rotation directions, rotation amounts, and rotation speeds of the motors with the rotary encoders. That is, the control unit 80 can detect driving directions, driving amounts, and driving speeds of driving targets.

The control unit 80 includes a CPU 81 that performs execution processing for a computer program, in other words, software, a volatile memory 82, and a nonvolatile memory 83. The CPU 81 performs various arithmetic operations necessary for executing a program 84 stored in the nonvolatile memory 83. The volatile memory 82 is used as a temporary data storage region. The nonvolatile memory 83 stores the program 84 and control parameters 85 necessary for executing the program 84. The program 84 includes programs for executing various kinds of processing explained below. The control parameters 85 include parameters for executing the program 84. The various kinds of processing explained below are implemented by the control unit 80 executing the program 84.

Print setting information, input of which is received via the operation panel 95, is stored in the nonvolatile memory 83.

Next, the medium feeding device 5 is explained in more detail with reference to FIG. 3 and the subsequent figures.

In FIG. 3, the medium feeding device 5 includes a base frame 57 as a base. The base frame 57 supports the feeding roller 50. The base frame 57 rotatably supports the placing unit 54. As explained in detail below, the base frame 57 guides the support unit 53 in a rising and falling direction.

The base frame 57 includes a side frame section 57a1 forming a side surface in the −Y direction and a side frame section 57a2 forming a side surface in the +Y direction.

A guide frame 58 is provided in the −Z direction with respect to the base frame 57. The guide frame 58 holds the separation roller 51 (see FIG. 1). The guide frame 58 has a leading end contact surface 58a, which is a surface with which the leading end of a medium supported by the support unit 53 and the placing unit 54 comes into contact. The leading end contact surface 58a extends along a rising and falling direction of the support unit 53.

Edge guides 55A and 55B that restrict edge positions in the Y-axis direction, that is, the width direction of the medium supported by the support unit 53 and the placing unit 54 are provided in the placing unit 54. The edge guide 55A restricts an edge position in the −Y direction of the medium. The edge guide 55B restricts an edge position in the +Y direction of the medium. The edge guides 55A and 55B are displaceable in the Y-axis direction and are displaced by a not-illustrated rack and pinion mechanism to approach or separate from each other.

Stacking restriction sections 55c that restrict the largest number of media supported by the support unit 53 and the placing unit 54 are provided in the edge guides 55A and 55B. In FIG. 3, the stacking restriction section 55c provided in the edge guide 55B is illustrated and the stacking restriction section 55c provided in the edge guide 55A is present at a hidden position. Reference sign Gp denotes a stacking height restricted by the stacking restriction section 55c, that is, a largest stacking height. The largest number of media may be referred to as largest stacking height. Since the thickness of a medium varies depending on a type, for example, the largest number of media in the case of plain paper is larger than the largest number of media of thick paper thicker than the plain paper. The largest stacking height is constant regardless of a type of a medium.

In the support unit 53, a friction pad 71, which is an example of a friction section, is provided at a position facing the feeding roller 50. The friction pad 71 is formed of a high friction material such as elastomer. Here, the high friction material means a material in which a coefficient of friction with a medium is higher than a coefficient of friction between media. Although the coefficient of friction between the media varies depending on a type of the media, a coefficient of friction between the friction pad 71 and the medium is higher than the coefficient of friction between the media regardless of the type of the media.

Since the friction pad 71 explained above is provided, in particular, when two media are placed on the support unit 53, it is possible to prevent a lowermost medium from being conveyed downstream following the uppermost medium.

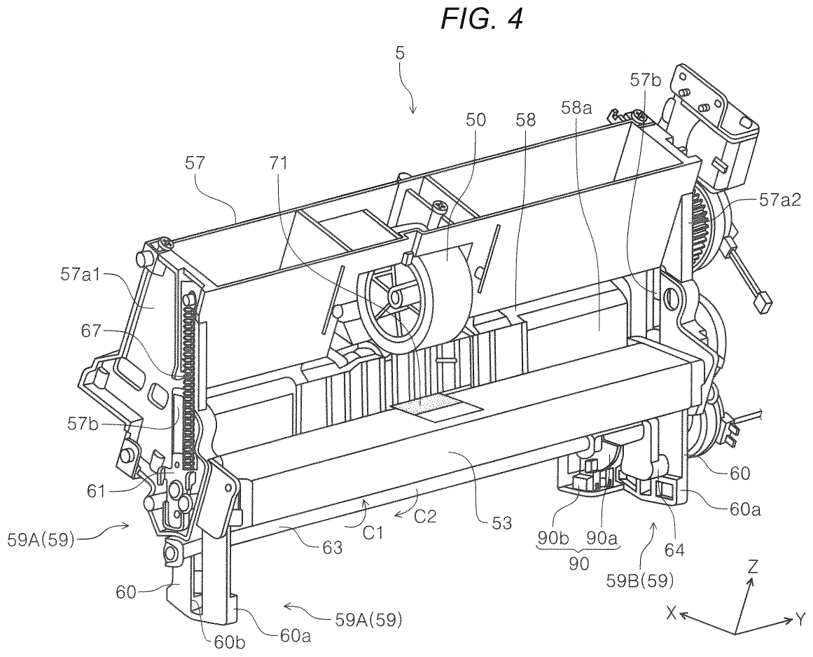

Next, a raising and lowering unit 59 that raises and lowers the support unit 53 is explained with reference to FIG. 4 and the subsequent figures.

The raising and lowering units 59 for raising and lowering the support unit 53 are provided in the side frame sections 57a1 and 57a2. The raising and lowering unit provided in the side frame section 57a1 is denoted by reference sign 59A and the raising and lowering unit provided in the side frame section 57a2 is denoted by reference sign 59B.

The raising and lowering unit 59 includes a shaft 63, the cam 64, a contact member 60, a guided member 61, an extension spring 67, and the cam drive motor 89 (see FIG. 2).

First, the contact members 60 are provided at both end portions in the Y-axis direction of the support unit 53. Therefore, the contact members 60 rise and fall integrally with the support unit 53. The contact member 60 provided at the −Y direction end portion and the contact member 60 provided at the +Y direction end portion are provided such that cam contact sections 60a explained below face each other.

In the side frame sections 57a1 and 57a2, guide grooves 57b are formed in the rising and falling direction of the support unit 53. In the present embodiment, the rising and falling direction of the support unit 53 includes the Z-axis direction as a main component and slightly includes a component in the X-axis direction, that is, is slightly inclined with respect to the Z-axis direction. Naturally, this is an example, and the rising and falling direction of the support unit 53 may not include an X-axis direction component and a Y-axis direction component and may be parallel to the Z-axis direction.

In the contact member 60 provided at the −Y direction end portion of the support unit 53, the guided member 61 is provided to sandwich the side frame section 57a1 between the guided member 61 and the contact member 60. The guided member 61 is guided in the rising and falling direction of the support unit 53 by the guide groove 57b of the side frame section 57a1. In the contact member 60 provided at the +Y direction end portion of the support unit 53, the guided member 61 is also provided to sandwich the side frame section 57a2 between the guided member 61 and the contact member 60 but is present at a hidden position in FIGS. 4 to 6. The guided member 61 is also guided in the rising and falling direction of the support unit 53 by the guide groove 57b of the side frame section 57a2.

As explained above, the support unit 53 is guided in the rising and falling direction by the base frame 57.

The extension spring 67 is hooked between the guided member 61 and the base frame 57. The support unit 53 is pressed toward the most raised position by a spring force of the extension spring 67. The support unit 53 is pressed in the +Z direction by the spring force of the extension spring 67. A direction in which the spring force of the extension spring 67 is applied is not limited to a direction parallel to the Z-axis direction and only has to include a +Z direction component. The extension spring 67 is an example of a pressing unit that presses the support unit 53 toward the most raised position.

The shaft 63 extending in the Y-axis direction is provided on the lower side of the support unit 53. The shaft 63 is rotatably supported by a not-illustrated bearing section. The shaft 63 is driven in a rotation direction C1 and a rotation direction C2 by power of the cam drive motor 89 (see FIG. 2).

The shaft 63 is provided to pierce through the contact member 60. A groove 60b is formed in the contact member 60 in the rising and falling direction of the support unit 53. The shaft 63 enters the groove 60b and relatively moves in the groove 60b according to rising and falling of the support unit 53 and the contact member 60.

The cam 64 is provided in the shaft 63. The cam 64 is provided at a position facing the contact member 60. A cam contact section 60a is provided at the lower end portion of the contact member 60. The cam 64 is engageable with the cam contact section 60a.

As explained above, the spring force of the extension spring 67 acts on the support unit 53 and the support unit 53 is always about to rise. However, when the cam 64 is rotated by the rotation of the shaft 63, the cam 64 comes into contact with the cam contact section 60a and pushes down the support unit 53 against the spring force of the extension spring 67. FIG. 4 illustrates a state in which the cam 64 pushes down the cam contact section 60a and the support unit 53 falls to the most lowered position. In this state, the cam 64 and the cam contact section 60a are engaged with each other.

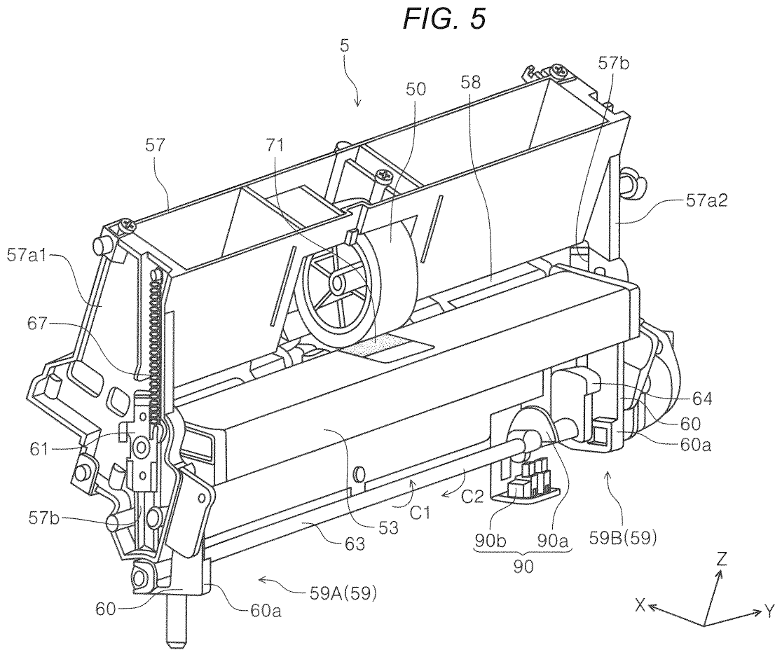

FIG. 5 illustrates a state in which the shaft 63 rotates in the rotation direction C1 from the state illustrated in FIG. 4, the cam 64 is separated from the cam contact section 60a, and the support unit 53 rises to the most raised position. A lifting limit, that is, a most raised position of the support unit 53 is specified by a not-illustrated rising restriction section provided in the base frame 57.

Transition from the state illustrated in FIG. 5 to the state illustrated in FIG. 4 is performed by the rotation of the shaft 63 in the rotation direction C2. That is, the shaft 63 and the cam 64 reciprocate between a phase illustrated in FIG. 4 and a phase illustrated in FIG. 5.

A plate to be detected 90a is provided in the shaft 63. The plate to be detected 90a configures a reference position sensor 90 in conjunction with a detection unit 90b. As illustrated in FIG. 4, since the plate to be detected 90a is present at a position detected by the detection unit 90b, the control unit 80 (see FIG. 2) can detect that the support unit 53 is present at the most lowered position. The control unit 80 can grasp a phase of the cam 64, can grasp the position of the support unit 53, and can appropriately control the rising and falling of the support unit 53 with a detection signal of the reference position sensor 90 explained above and a detection signal of a not-illustrated rotary encoder that detects the rotation of the cam drive motor 89 (refer to FIG. 2).

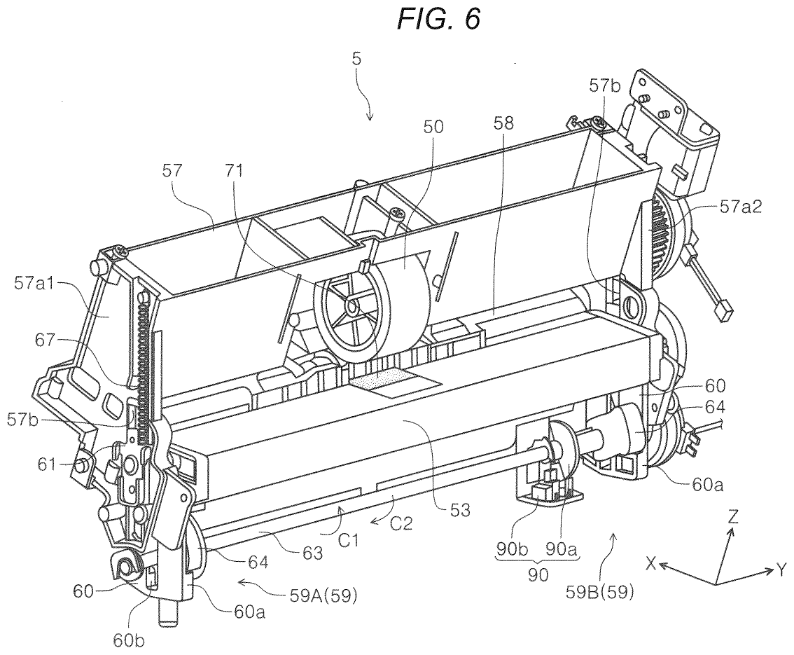

Subsequently, FIG. 6 illustrates a state in which the support unit 53 is located at a restriction position. The restriction position is present between the most raised position and the most lowered position and is a position where the cam contact section 60a comes into contact with the cam 64 to restrict further rising of the support unit 53. The control unit 80 can control the cam drive motor 89 to set the phase of the cam 64 to the phase illustrated in FIG. 6.

The state illustrated in FIG. 5 is an example of a first state in which the raising and lowering unit 59, that is, the cam 64 allows the support unit 53 to rise. FIG. 6 is an example of a second state in which the raising and lowering unit 59, that is, the cam 64 restricts rising of the support unit 53 from the restriction position between the most raised position and the most lowered position to a high position. FIG. 4 is an example of a third state in which the raising and lowering unit 59, that is, the cam 64 positions the support unit 53 at the most lowered position. The first, second, and third states of the raising and lowering unit 59 are not specified by the position of the support unit 53 and are specified by a phase of the cam 64. That is, the cam 64 takes, in the first state, a first phase in which the cam 64 is separated from the cam contact section 60a, takes, in the second state, a second phase in which the cam 64 pushes down the cam contact section 60a, and takes, in the third state, a third phase in which the cam 64 pushes down the cam contact section 60a to the most lowered position.

In a feeding standby state, the raising and lowering unit 59, that is, the cam 64 takes the third state illustrated in FIG. 4. When feeding of a medium is started, the raising and lowering unit 59, that is, the cam 64 switches the first state illustrated in FIG. 5 and the second state illustrated in FIG. 6 every time the medium is fed.

The first state, the second state, and the third state may be treated as indicating states of the raising and lowering unit 59 or may be treated as indicating states of the cam 64.

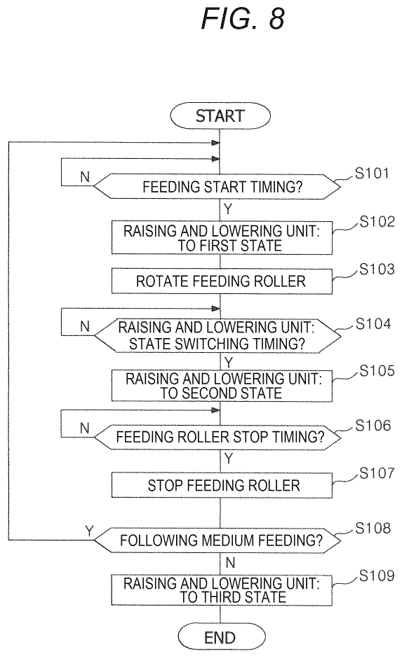

Hereinafter, feeding control performed by the control unit 80 is explained with reference to FIG. 8.

In the feeding standby state, the raising and lowering unit 59, that is, the cam 64 is in the third state. When receiving feeding start timing for a medium, for example, recording data (Yes in step S101), the control unit 80 switches the raising and lowering unit 59 to the first state (step S102). Accordingly, the uppermost medium P1 among the media P1 supported by the support unit 53 comes into contact with the feeding roller 50.

Subsequently, the control unit 80 rotates the feeding roller 50 (step S103). Accordingly, the uppermost medium P1 among the media P1 supported by the support unit 53 is delivered. Note that step S102 and step S103 may be simultaneously executed or step S102 may be executed after step S103.

Subsequently, when determining that it is state switching timing for the raising and lowering unit 59 (Yes in step S104), the control unit 80 switches the raising and lowering unit 59 from the first state to the second state (step S105). The state switching timing in step S104 is explained below.

Subsequently, when determining that it is stop timing for the feeding roller 50 (Yes in step S106), the control unit 80 stops the driving of the feeding roller 50 (step S107). The stop timing in step S106 is explained below.

Subsequently, when the following medium is fed (Yes in step S108), the control unit 80 repeatedly executes step S101 and subsequent steps. When the following medium is fed, the feeding start timing in step S101 is, for example, timing when a predetermined interval is formed between the trailing end of the preceding medium and the leading end of the following medium.

When the following medium is not fed (No in step S108), the control unit 80 switches the raising and lowering unit 59 from the second state to the third state (step S109).

As explained above, the raising and lowering unit 59 switches the first state and the second state every time the medium is fed (steps S102 and S105).

The control unit 80 rotates the feeding roller 50 in a state in which the conveyance roller pair 34 is stopped and causes the leading end of the medium to abut against the conveyance roller pair 34. Accordingly, the control unit 80 corrects skew of the leading end of the medium. Thereafter, the control unit 80 causes the conveyance roller pair 34 and the feeding roller 50 to rotate in synchronization until the trailing end of the medium passes through between the feeding roller 50 and the separation roller 51. At this time, the control unit 80 controls the conveyance roller pair 34 and the feeding roller 50 such that a state in which a bend is formed in the medium between the conveyance roller pair 34 and the feeding roller 50 is maintained. However, in the case of in a medium having high rigidity such as thick paper, in some case, a bend is not formed between the conveyance roller pair 34 and the feeding roller 50.

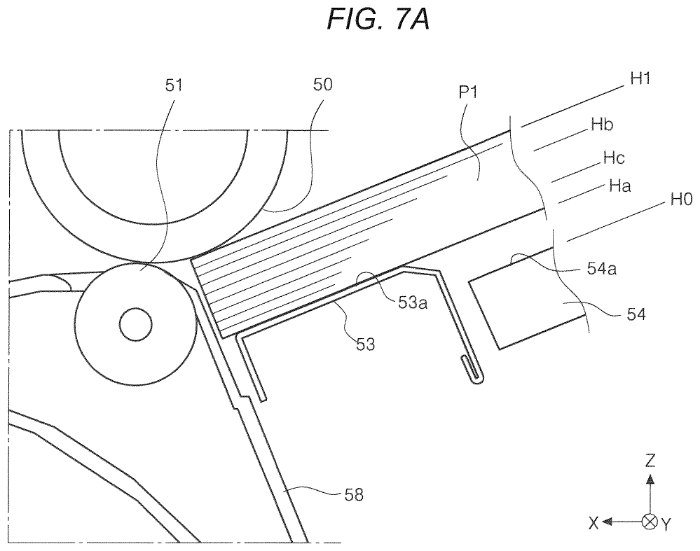

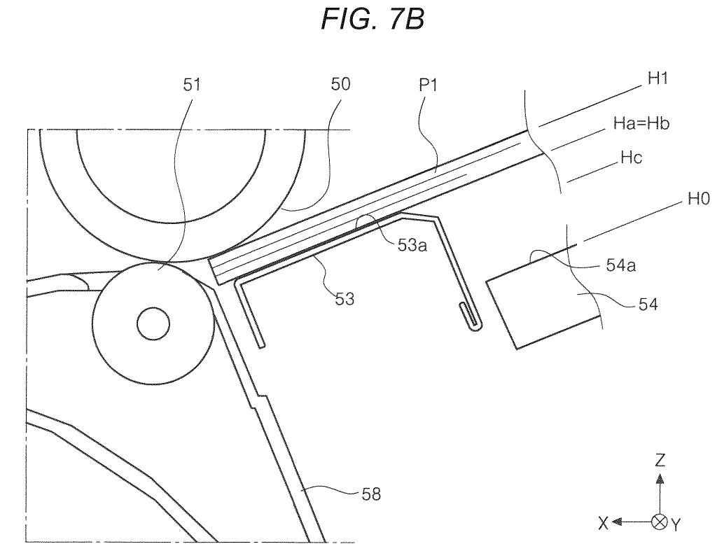

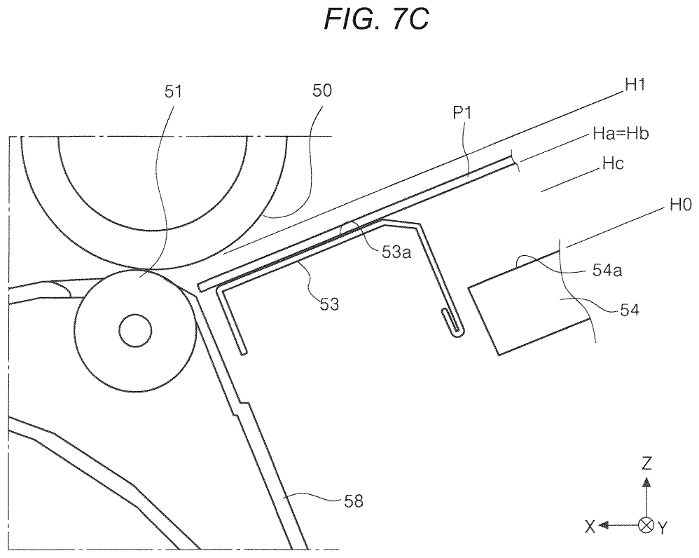

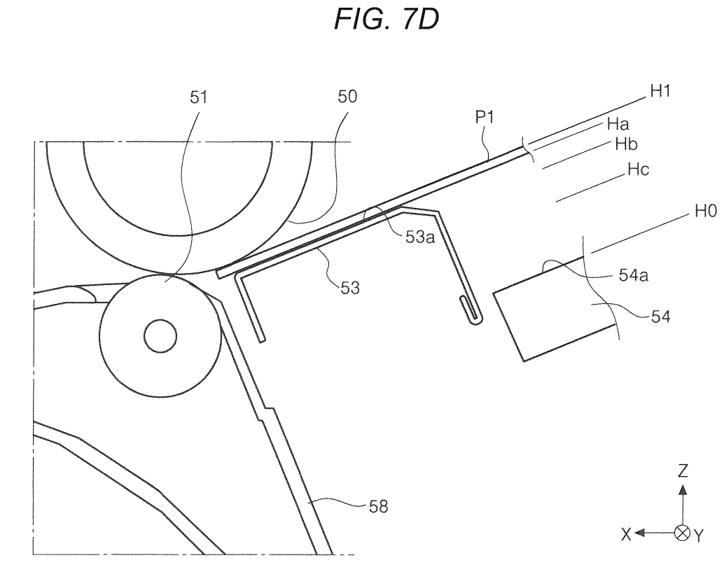

Hereinafter, the position of the support unit 53 is explained in detail with reference to FIGS. 7A to 7D.

In FIGS. 7A to 7D, reference signs H0, H1, Ha, Hb, and Hc are respectively positions in the rising and falling direction of the support unit 53 based on an upper surface 53a of the support unit 53.

A position indicated by reference sign H0 is the most lowered position of the support unit 53 and a position indicated by reference sign H1 is the most raised position of the support unit 53. The most raised position H1 is a position where the upper surface 53a of the support unit 53 comes into contact with the feeding roller 50. However, the most raised position H1 may be below the position where the upper surface 53a of the support unit 53 comes into contact with the feeding roller 50.

The most lowered position H0 is a position where the upper surface 53a of the support unit 53 is flush with an upper surface 54a of the placing unit 54. Naturally, the most lowered position H0 is not limited to the position where the upper surface 53a is flush with the upper surface 54a. The upper surface 53a may be above or below the upper surface 54a.

The support unit 53 rises and falls between the most lowered position H0 and the most raised position H1.

A position indicated by reference sign Hc is an intermediate position between the most raised position H1 and the most lowered position H0. A position indicated by reference sign Hb is the restriction position explained above. A position indicated by reference sign Ha is the current position of the support unit 53 in the figures.

FIG. 7A is a diagram illustrating a state in which the largest number of media P1 are placed on the support unit 53 and the placing unit 54. In this state, the uppermost medium P1 comes into contact with the feeding roller 50 with a pressing force of the extension spring 67 and the uppermost medium P1 is sent downstream by the rotation of the feeding roller 50.

The raising and lowering unit 59, that is, the cam 64 is switched from the third state (see FIG. 4) to the first state (see FIG. 5).

The control unit 80 (see FIG. 2) switches the raising and lowering unit 59, that is, the cam 64 to the second state at predetermined timing after the leading end of the fed medium P1 is nipped by the feeding roller 50 and the separation roller 51. This timing is the state switching timing illustrated in step S104 in FIG. 8.

The state switching timing may be timing when the feeding roller 50 rotates a predetermined amount after starting rotation, may be timing when a predetermined time has elapsed after the feeding roller 50 started the rotation, or may be timing when a medium detection sensor (not illustrated) provided further downstream than a nip position between the feeding roller 50 and the separation roller 51 detects the leading end of the medium. The medium detection sensor may be provided in the vicinity of downstream of the nip position between the feeding roller 50 and the separation roller 51 or may be provided in the vicinity of upstream of the conveyance roller pair 34 (see FIG. 1).

However, it is suitable that timing when the raising and lowering unit 59, that is, the cam 64 is switched to the second state is earlier than timing when the trailing end of the delivered medium P1 passes through between the feeding roller 50 and the support unit 53.

Then, the control unit 80 stops, based on size information included in the acquired recording data, the rotation of the feeding roller 50 at timing when the trailing end of the uppermost medium P1 passes through the feeding roller 50. The leading end of the delivered medium P1 reaches the conveyance roller pair 34 (see FIG. 1) at timing earlier than timing when the trailing end of the fed medium P1 passes through the feeding roller 50.

Here, when the largest number of media P1 are stacked on the support unit 53, the current position Ha of the support unit 53 is located below the restriction position Hb. For this reason, even when the cam 64 pushes down the cam contact section 60a and changes to the second state, the support unit 53 does not fall and maintains the current position Ha. That is, even when the raising and lowering unit 59, that is, the cam 64 is switched from the first state to the second state, the state illustrated in FIG. 7A is maintained.

According to a decrease in the number of stacked media, the current position Ha of the support unit 53 in the second state of the raising and lowering unit 59 moves from a position lower than the restriction position Hb to the restriction position Hb. However, in this process, a state in which the medium P1 supported by the support unit 53 is in contact with the feeding roller 50 is maintained. That is, even when a state change between the first state and the second state of the raising and lowering unit 59, that is, the cam 64 occurs, a rising and falling motion of the support unit 53 does not occur.

FIG. 7B is a diagram of a state in which the current position Ha of the support unit 53 reaches the restriction position Hb according to a decrease in the number of stacked media. When the current position Ha of the support unit 53 reaches the restriction position Hb, the current position Ha of the support unit 53 in the second state of the raising and lowering unit 59, that is, the cam 64 does not become higher than the restriction position Hb. When the number of stacked media further decreases from this state, since an interval is formed between the uppermost medium P1 and the feeding roller 50 in the second state of the raising and lowering unit 59, that is, the cam 64, the support unit 53 performs a rising and lowering motion when the state switching between the first state and the second state of the raising and lowering unit 59, that is, the cam 64 occurs.

FIG. 7C illustrates a state in which the number of stacked media is remaining one as an example. The raising and lowering unit 59, that is, the cam 64 is in the second state. When the raising and lowering unit 59, that is, the cam 64 is switched to the first state in order to feed the last medium P1 from this state, the current position Ha of the support unit 53 becomes higher than the restriction position Hb as indicated by a change from FIG. 7C to FIG. 7D. That is, when the state change between the first state and the second state of the raising and lowering unit 59, that is, the cam 64 occurs, the support unit 53 rises and falls.

Here, when the trailing end of the last medium P1 passes through between the feeding roller 50 and the support unit 53, since the current position Ha of the support unit 53 is at the restriction position Hb as illustrated in FIG. 7C, the feeding roller 50 and the support unit 53, more specifically, the feeding roller 50 and the friction pad 71 do not come into contact with each other.

When the last medium P1 is fed, if the rising of the support unit 53 is still allowed at timing when the trailing end of the medium P1 passes through between the feeding roller 50 and the friction pad 71, after the trailing end of the medium P1 passes through between the feeding roller 50 and the friction pad 71, the feeding roller 50 is likely to receive rotation resistance because of contact with the friction pad 71 and rotation speed may decrease. At this time, when recording is performed while the medium P1 is conveyed by the downstream conveyance roller pair 34 (refer to FIG. 1), the medium P1 receives a conveyance load from the feeding roller 50 and, as a result, it is likely that conveyance accuracy of the medium P1 is deteriorated and recording quality is deteriorated.

When, in order to avoid such a problem, the support unit 53 is raised and lowered every time a medium is fed, the throughput of feeding decreases.

However, in the medium feeding device 5 according to the present embodiment, as explained above, when the number of stacked media on the support unit 53 is the largest number, in the second state of the raising and lowering unit 59, the support unit 53 is present at a position lower than the restriction position Hb and the medium supported by the support unit 53 comes into contact with the feeding roller 50.

The position of the support unit 53 in the second state of the raising and lowering unit 59 moves from a position lower than the restriction position Hb to the restriction position Hb according to a decrease in the number of stacked media. A state in which the medium supported by the support unit 53 comes into contact with the feeding roller 50 is maintained. Accordingly, it is possible to suppress a decrease in throughput of the medium feeding without the rising and falling motion of the support unit 53 intervening.

When at least the number of stacked media is one, in the second state of the raising and lowering unit 59, the support unit 53 is present at the restriction position Hb and the medium supported by the support unit 53 is separated from the feeding roller 50. Accordingly, it is possible to suppress a deficiency caused by the feeding roller 50 and the support unit 53 coming into contact with each other.

As explained above, with the medium feeding device 5, while suppressing a decrease in throughput of the medium feeding, it is possible to suppress a deficiency caused by the feeding roller 50 and the support unit 53 coming into contact with each other.

Examples of the deficiency caused by the feeding roller 50 and the support unit 53 coming into contact with each other include, besides the deterioration in the recording quality due to the contact between the feeding roller 50 and the friction pad 71 explained above, occurrence of noise due to contact between the feeding roller 50 and the friction pad 71 and wear of the feeding roller 50 and the friction pad 71.

In the present embodiment, when the number of stacked media is equal to or less than half of the largest number, the support unit 53 is located at the restriction position Hb in the second state of the raising and lowering unit 59. Accordingly, the state in which the medium supported by the support unit 53 comes into contact with the feeding roller 50 is maintained during feeding of half or more media among the largest number of media. Accordingly, it is possible to effectively suppress a decrease in throughput of the medium feeding.

In the present embodiment, when the number of stacked media is five or less, the support unit 53 is located at the restriction position Hb in the second state of the raising and lowering unit 59. More specifically, in the present embodiment, when the number of stacked media is three or less in the case of plain paper, the support unit 53 is located at the restriction position Hb in the second state of the raising and lowering unit 59.

Accordingly, the state in which the medium supported by the support unit 53 comes into contact with the feeding roller 50 is maintained during feeding of a large number of media. Accordingly, it is possible to effectively suppress a decrease in throughput of the medium feeding.

The largest number of media is, for example, 150 in the case of plain paper having thickness of 0.11 mm and stacking height, that is, the largest stacking height in this case is 16.5 mm.

In the present embodiment, when the support unit 53 is at the most lowered position H0, the upper surface 53a of the support unit 53 and the upper surface 54a of the placing unit 54 are flush with each other, that is, form the same plane. Accordingly, it is possible to more appropriately support the medium.

In the present embodiment, the raising and lowering unit 59 includes the cam 64 that is rotationally driven, the support unit 53 includes the cam contact section 60a that comes into contact with the cam 64, and the support unit 53 rises and falls according to the rotation of the cam 64.

Accordingly, the support unit 53 can be raised and lowered with a simple configuration.

The raising and lowering unit 59 includes the extension spring 67 serving the pressing unit that presses the support unit 53 toward the most lifted position H1. The cam 64 takes, in the first state, the first phase of being separated from the cam contact section 60a and takes, in the second state, the second phase of pressing down the cam contact section 60a. In this way, the support unit 53 can be raised and lowered with a simple configuration by the extension spring 67 and the cam 64.

In the present embodiment, there is a period in which the medium fed by the feeding roller 50 faces the line head 12 to be recorded. In such a configuration, a conveyance load applied to the medium by the feeding roller 50 is likely to cause deterioration in recording accuracy. In particular, when media on the support unit 53 run out and the feeding roller 50 and the friction pad 71 of the support unit 53 come into direct contact with each other, the feeding roller 50 receives frictional resistance from the friction pad 71, rotation speed decreases, and a conveyance load is applied to the medium to cause the deterioration in the recording accuracy. However, with the action effects of the present embodiment explained above, the feeding roller 50 and the friction pad 71 are prevented from coming into direct contact with each other and it is possible to suppress the deterioration in the recording accuracy.

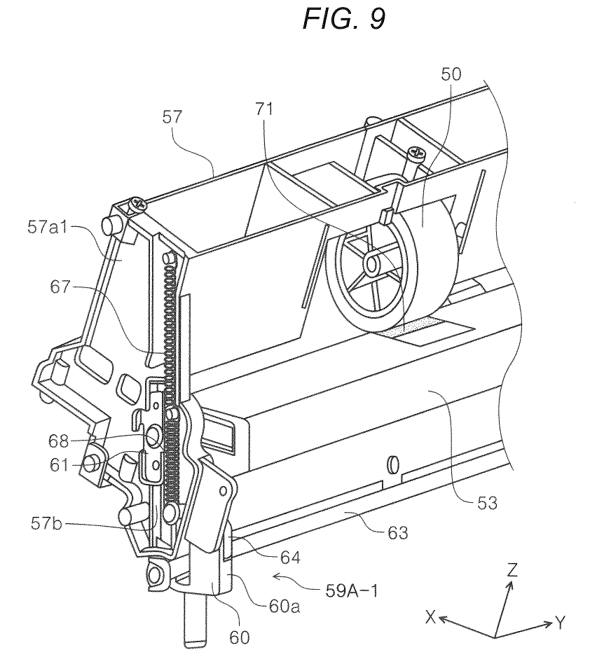

Subsequently, with reference to FIG. 9, a configuration including a shock absorbing unit that absorbs a shock at the time when the medium supported by the support unit 53 comes into contact with the feeding roller 50 according to rising of the support unit 53 is explained.

A raising and lowering unit 59A-1 illustrated in FIG. 9 includes an extension spring 68 as the shock absorbing unit. The extension spring 68 is hooked between the guided member 61 and the base frame 57 and applies, to the support unit 53, a pressing force in a direction toward the most lowered position H0.

The support unit 53 is pressed in the −Z direction by a spring force of the extension spring 68. A direction in which the spring force of the extension spring 68 is applied is not limited to a direction parallel to the Z-axis direction and only has to include a −Z direction component.

Accordingly, a shock at the time when the medium supported by the support unit 53 comes into contact with the feeding roller 50 is reduced and it is possible to suppress collision sound at the time when the medium supported by the support unit 53 comes into contact with the feeding roller 50.

In the present embodiment, since the shock absorbing unit includes the extension spring 68, the shock absorbing unit can be easily configured. Since the pressing force of the extension spring 68 increases when the support unit 53 rises, it is possible to effectively reduce the shock at the time when the medium supported by the support unit 53 comes into contact with the feeding roller 50.

The shock absorbing unit is not limited to the extension spring 68 and may include an elastic material that temporarily applies a pressing force to the support unit 53 when the medium comes into contact with the feeding roller 50. Such an elastic material can include, for example, a compression coil spring or rubber.

The shock absorbing unit may be provided not only in the raising and lowering unit 59A-1 provided in the −Y direction but also in an raising and lowering unit (not illustrated) provided in the +Y direction.

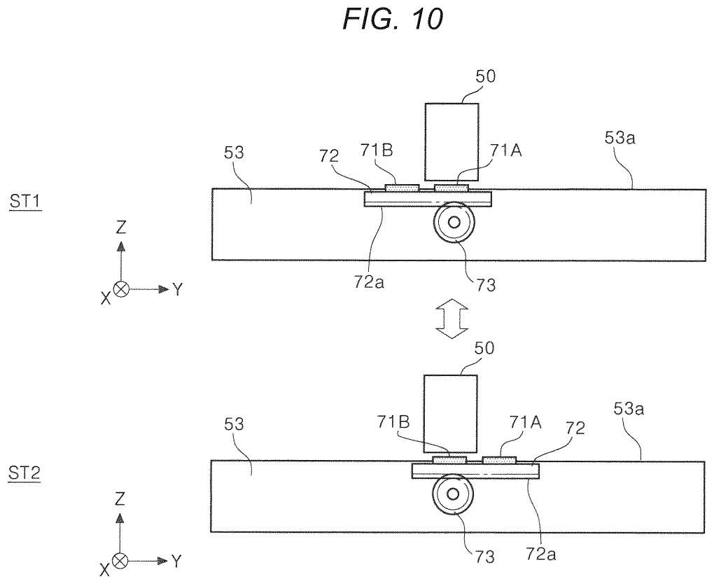

Subsequently, a configuration in which the support unit 53 includes different types of friction pads is explained with reference to FIG. 10.

In FIG. 10, reference sign 71A denotes a first friction pad. The first friction pad 71A is an example of a first friction section in which a coefficient of friction between the first friction section and a medium is a first coefficient of friction. Reference sign 71B denotes a second friction pad. The second friction pad 71B is an example of a second friction section in which a coefficient of friction between the second friction section and a medium is a second coefficient of friction larger than the first coefficient of friction. The first friction pad 71A and the second friction pad 71B can be switched.

More specifically, a rack member 72 is provided to be displaceable in the Y-axis direction with respect to the support unit 53. The first friction pad 71A and the second friction pad 71B are provided at an interval in the Y-axis direction in the rack member 72.

In the rack member 72, a rack 72a is formed in the Y-axis direction. A pinion 73 meshes with the rack 72a to configure a rack and pinion mechanism. The pinion 73 is driven by a not-illustrated motor controlled by the control unit 80 (see FIG. 2).

A state ST1 illustrated in FIG. 10 is a state in which the first friction pad 71A faces the feeding roller 50. A state ST2 illustrated in FIG. 10 is a state in which the second friction pad 71B faces the feeding roller 50.

With the configuration explained above, the first friction pad 71A and the second friction pad 71B can be switched according to a type of a medium and more appropriate feeding can be implemented.

For example, the control unit 80 selects the first friction pad 71A when a first medium is fed and selects the second friction pad 71B when a second medium having a larger coefficient of friction between media than the first medium is fed. Examples of the first medium include thick paper and an envelope and examples of the second medium include plain paper. Accordingly, more appropriate feeding can be implemented.

The switching of the first friction pad 71A and the second friction pad 71B is not limited to automatic switching and may be performed manually.

In order to prevent a friction pad not facing the feeding roller 50 from adversely affecting feeding of the last medium, for example, the upper surface of the rack member 72 may be formed in a curved shape convex upward and the friction pad not facing the feeding roller 50 may be configured to retract to the lower side from the upper surface 53a of the support unit 53.

The present disclosure is not limited to the embodiment and the modified examples explained above and various modifications can be made within the scope of the disclosure set forth in the appended claims, and it is obvious that these modifications also fall within the scope of the present disclosure.

What is claimed is:

1. A medium feeding device comprising:
a feeding unit configured to feed a medium;
a support unit configured to support the medium, the support unit being capable of rising and falling between a most raised position that is a position where the support unit is closest to the feeding unit and a most lowered position that is a position where the support unit is most separated from the feeding unit; and
a raising and lowering unit configured to raise and lower the support unit, wherein
the raising and lowering unit switches, every time the medium is fed,
a first state in which the rising of the support unit is allowed and
a second state in which the rising of the support unit from a restriction position between the most raised position and the most lowered position to a position higher than the restriction position is restricted,
when a number of stacked media on the support unit is a largest number, in the second state, the support unit is present at a position lower than the restriction position, the medium supported by the support unit comes into contact with the feeding unit,
a position of the support unit in the second state moves from the position lower than the restriction position to the restriction position according to a decrease in the number of stacked media, and a state in which the medium supported by the support unit is in contact with the feeding unit is maintained, and
when at least the number of stacked media is one, in the second state, the support unit is present at the restriction position, and the medium supported by the support unit is separated from the feeding unit.

2. The medium feeding device according to claim 1, wherein the support unit is located at the restriction position in the second state when the number of stacked media is equal to or less than half of the largest number of media.

3. The medium feeding device according to claim 1, wherein the support unit is located at the restriction position in the second state when the number of stacked media is five or less.

4. The medium feeding device according to claim 1, further comprising a placing unit configured to support the medium in conjunction with the support unit, wherein
the support unit moves relatively to the placing unit in the rising and falling, and
the support unit and the placing unit form a same plane when the support unit is present at the most lowered position.

5. The medium feeding device according to claim 1, wherein
the raising and lowering unit includes a cam that is rotationally driven,
the support unit includes a cam contact section that comes into contact with the cam, and
the support unit is lifted and lowered by the rotation of the cam.

6. The medium feeding device according to claim 5, wherein
the raising and lowering unit includes a pressing unit configured to press the support unit toward the most raised position, and
the cam takes, in the first state, a first phase in which the cam is separated from the cam contact section and takes, in the second state, a second phase in which the cam presses down the cam contact section.

7. The medium feeding device according to claim 1, wherein the raising and lowering unit includes a shock absorbing unit configured to absorb a shock at a time when the medium supported by the support unit comes into contact with the feeding unit according to the rising of the support unit.

8. The medium feeding device according to claim 7, wherein
the shock absorbing unit includes an extension spring that presses the support unit toward the most lowered position, and
a pressing force of the extension spring increases when the support unit rises.

9. The medium feeding device according to claim 1, wherein the support unit includes a friction section at a position facing the feeding unit.

10. The medium feeding device according to claim 1, wherein
the support unit includes a friction section at a position facing the feeding unit,
the friction section includes:
a first friction section in which a coefficient of friction between the first friction section and the medium is a first coefficient of friction; and
a second friction section in which a coefficient of friction between the second friction section and the medium is a second coefficient of friction larger than the first coefficient of friction, and
the first friction section and the second friction section can be switched.

11. The medium feeding device according to claim 10, further comprising a control unit configured to control the switching of the first friction section and the second friction section, wherein
the control unit selects the first friction section when a first medium is fed and selects the second friction section when a second medium having a larger coefficient of friction between media than the first medium is fed.

12. A recording apparatus comprising:
the medium feeding device according to claim 1; and
a recording unit configured to perform recording on the medium fed by the medium feeding device.

13. The recording apparatus according to claim 12, wherein the medium fed by the feeding unit faces the recording unit.
